(19) United States
(12) Patent Application Publication
(10) Pub. No.: US 2013/0145067 A1
(43) Pub. Date: Jun. 6, 2013

(54) ELECTRONIC DEVICE CAPABLE OF CONNECTING DIFFERENT EXPANDING DEVICES THROUGH SAS EXPANDER AND CONNECTING METHOD THEREOF

(71) Applicant: CHIH-HUANG WU, Tu-Cheng (TW)

(72) Inventor: CHIH-HUANG WU, Tu-Cheng (TW)

(73) Assignee: HON HAI PRECISION INDUSTRY CO., LTD., Tu-Cheng (TW)

(21) Appl. No.: 13/340,711

(22) Filed: Dec. 30, 2011

(30) Foreign Application Priority Data
Dec. 2, 2011 (TW) 100144530

(51) Int. Cl. G06F 13/00

(52) U.S. Cl. 710/300

(57) ABSTRACT

An electronic device is capable of connecting different expanding devices. The electronic device includes a Serial Attached Small Computer System interface (SAS) Expander, which includes a storage unit for storing a firmware of the SAS Expander, the firmware accommodating a physical layer attribute of any expanding device to be connected to the SAS Expander. The device further includes a processing unit to detect a physical layer attribute of an expanding device and parameters of the physical layer attribute when the expanding device is first connected to the SAS Expander, determine whether a firmware stored in the storage unit corresponds to the detected physical layer attribute, and write the detected parameters into the storage unit to form a new firmware if there is no firmware stored in the storage unit corresponding to the detected physical layer attribute.

### BACKGROUND

1. Technical Field

The present disclosure relates to electronic devices capable of adaptively connecting different expanding devices through Serial Attached Small Computer System Interface Expanders and connecting methods thereof.

2. Description of Related Art

Firmware corresponding to a physical layer attribute (Direct Routing, Table Routing, or Subtractive Routing) of an expanding device should be stored in an SAS (Serial Attached SCSI (Small Computer System Interface)) Expander before an expanding device, such as a Hard Disk Drive (HDD) or a SAS Expander is connected to the SAS Expander of an electronic device. Once the firmware of the SAS Expander is established, only expanding devices with the physical layer attribute corresponding to the firmware can be connected to the SAS Expander. Therefore, an electronic device capable of adaptively connecting different expanding devices through a SAS Expander is needed.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic diagram showing the connective relationships between an electronic device capable of connecting different expanding devices through a SAS Expander and the different expanding devices, in accordance with an exemplary embodiment.

FIG. 2 is a schematic, block diagram of the electronic device of FIG. 1.

FIG. 3 is a flowchart of a connecting method of the electronic device of FIG. 1 to adaptively connect different expanding devices through the SAS Expander, in accordance with an exemplary embodiment.

### DETAILED DESCRIPTION

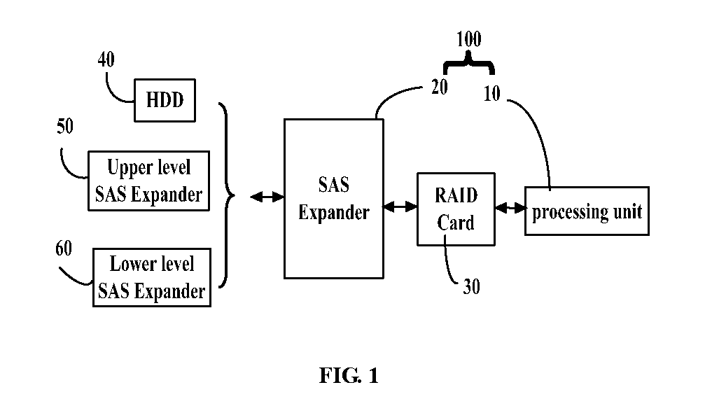

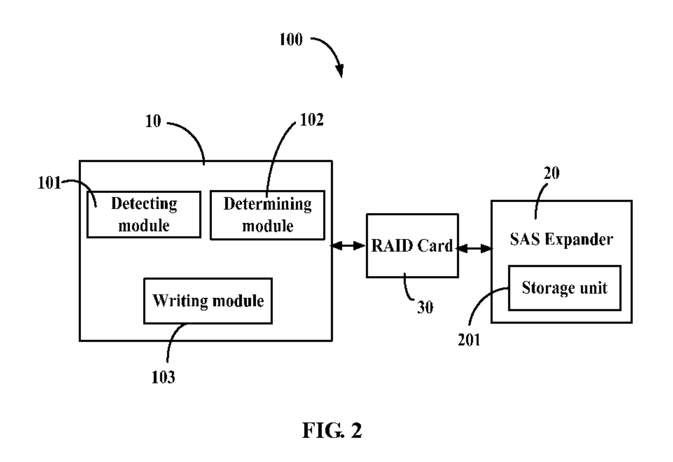

Referring to FIGS. 1 and 2, an electronic device 100 is capable of adaptively connecting different expanding devices through an SAS Expander 20. The device 100 includes a processing unit 10. The processing unit 10 is electrically connected to the SAS Expander 20 through a RAID Card 30. The device 100 may be a device storing mass data, such as a data server.

The SAS Expander 20 is capable of being connected to an expanding device with a physical layer attribute of Direct Routing (D), or Table Routing (T), or Subtractive Routing (S). The SAS Expander 20 includes a storage unit 201, a flash memory for example, to store firmware of the SAS Expander 20. The firmware accommodates the physical layer attribute(s) of any expanding device to be connected to the SAS Expander 20. The expanding device with the physical layer attribute can be recognized by the expander 20 if the corresponding firmware is pre-stored in the storage unit 201. For example, when the firmware of the SAS Expander 20 corresponds to a physical layer attribute D, a RAID Card 30 with the physical layer attribute D or a Hard Disk Drive (HDD) 40 with the physical layer attribute D can be recognized by the Expander 20. When the firmware corresponds to a physical layer attribute T, an upper level SAS Expander 50 with the physical layer attribute T can be recognized by the Expander 20. When the firmware corresponds to a physical layer attribute S, a lower level SAS Expander 60 with the physical layer attribute S can be recognized by the Expander 20.

The processing unit 10 includes a detecting module 101, a determining module 102, and a writing module 103. The detecting module 101 detects a physical layer attribute of an expanding device and parameters of the physical layer attribute when the expanding device is first connected to the SAS Expander 20. The determining module 102 determines whether a firmware stored in the storage unit 201 corresponds to the detected physical layer attribute. The writing module 103 writes the detected parameters into the storage unit 201 to form a new firmware if there is no firmware stored in the storage unit 201 corresponding to the detected physical layer attribute. In this embodiment, after forming the new firmware, the writing module 103 further restarts the electronic device 100.

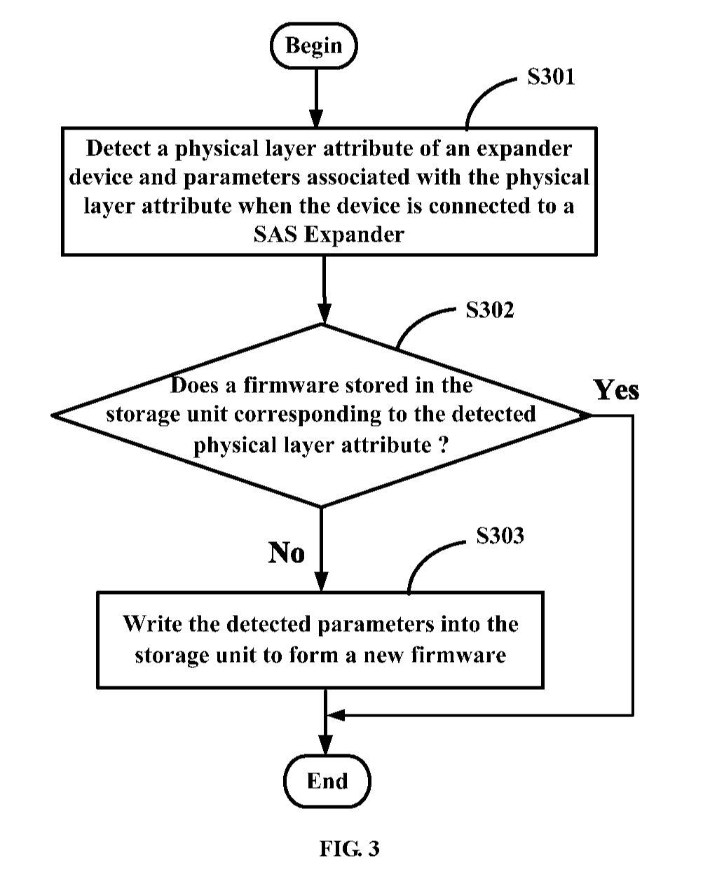

Referring to FIG. 3, a flowchart of a connecting method of the electronic device to adaptively connect different expanding devices through a SAS Expander is shown.

In step S301, the detecting module 101 is implemented by the processor 10 to detect a physical layer attribute of an expander device and parameters of the physical layer attribute when the device is first connected to the SAS Expander 20.

In step S302, the determining module 102 is implemented by the processor 10 to determine whether a firmware already stored in the storage unit 201 corresponds to the detected physical layer attribute. If there is no firmware stored in the storage unit 201 corresponding to the detected physical layer attribute, the procedure goes to step S303. If there exists firmware stored in the storage unit 201 corresponding to the detected physical layer attribute, the procedure ends.

In step S303, the writing module 103 is implemented by the processor 10 to write the detected parameters into the storage unit 201 to form a new firmware.

In this embodiment, after forming the new firmware, the writing module 103 is further implemented by the processor 10 to restart the device 100.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device capable of connecting to different expanding devices, the electronic device comprising:
a Serial Attached Small Computer System interface (SAS) Expander, comprising a storage unit for storing a firmware of the SAS Expander, the firmware accommodating a physical layer attribute of any expanding device to be connected to the SAS Expander, an expanding device with a physical layer attribute being capable of being recognized by the SAS Expander if a corresponding firmware is pre-stored in the storage unit; and
a processing unit to:
detect a physical layer attribute of an expanding device and parameters of the physical layer attribute when the expanding device is first connected to the SAS Expander;
determine whether a firmware stored in the storage unit corresponds to the detected physical layer attribute; and
write the detected parameters into the storage unit to form a new firmware if there is no firmware stored in the storage unit corresponding to the detected physical layer attribute.

2. The electronic device as described in claim 1, wherein the processing unit is further configured to:
restart the electronic device after the new firmware is formed.

3. The electronic device as described in claim 1, wherein the expanding device is a Raid Card, a Hard Disk Drive, or a SAS Expander.

4. The testing device as described in claim 1, wherein the processing unit is electrically connected to the SAS Expander through a RAID Card.

5. A connecting method for connecting different expanding devices to an electronic device through a Serial Attached Small Computer System interface (SAS) Expander of the electronic device, the SAS Expander comprising a storage unit for storing a firmware of the SAS Expander, the firmware accommodating a physical layer attribute of any expanding device to be connected to the SAS Expander, an expanding device with a physical layer attribute being capable of being recognized by the SAS Expander if a corresponding firmware is pre-stored in the storage unit, the connecting method comprising:
detecting a physical layer attribute of an expanding device and parameters of the physical layer attribute when the expanding device is first connected to the SAS Expander;
determining whether a firmware stored in the storage unit corresponds to the detected physical layer attribute; and
writing the detected parameters into the storage unit to form a new firmware if there is no firmware stored in the storage unit corresponding to the detected physical layer attribute.

6. The connecting method as described in claim 5 further comprising: restarting the electronic device after the new firmware is formed.
